(19) United States
(12) Patent Application Publication
(10) Pub. No.: US 2016/0088234 A1
(43) Pub. Date: Mar. 24, 2016

(54) VIDEO RELAY DEVICE

(71) Applicant: Kabushiki Kaisha Toshiba, Tokyo (JP)

(72) Inventor: Takashi Doi, Fuchu Tokyo (JP)

(21) Appl. No.: 14/667,473

(22) Filed: Mar. 24, 2015

Related U.S. Application Data
(60) Provisional application No. 62/052,793, filed on Sep. 19, 2014.

(51) Int. Cl. H04N 5/268; H04N 5/44; H04N 5/38

(52) U.S. Cl. CPC H04N 5/268; H04N 5/38; H04N 5/44

(57) ABSTRACT

According to one embodiment, an video relay device includes a first port, a second port, and a transmission module. The first port is configured to connect to a video receiver compatible with an interface standard for video transmission. The second port is configured to connect to a plurality of video transmitters. The transmission module transmits a video signal indicating the video transmitters connected to the second port when it is determined that, in communication with the video receiver connected to the first port, the video receiver has a first version incompatible with connection to the video transmitters among a plurality of versions defined in the interface standard.

### CROSS-REFERENCE TO RELATED APPLICATIONS

This application claims the benefit of U.S. Provisional Patent Application No. 62/052,793, filed Sep. 19, 2014, the entire contents of which are incorporated herein by reference.

### FIELD

Embodiments described herein relate generally to a video relay device.

### BACKGROUND

In recent years, mobile devices, such as smartphones or tablets, capable of displaying high-definition video have been widespread. To cope with sophisticated functions of such mobile devices, for example, Mobile High-Definition Link (MHL) standard or the like has been developed as a video transmission technology between mobile devices and televisions or the like. With upgrading a version of the MHL standard, a sink device is enabled to connect to a plurality of source devices via a repeater device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of a configuration of a video transmission system according to an embodiment;

FIG. 2 is an exemplary block diagram illustrating an example of a configuration of an MHL repeater device in the embodiment;

FIG. 3 is an exemplary diagram illustrating an example of a screen generated by a screen generation module in the embodiment;

FIG. 4 is an exemplary flowchart illustrating the procedure of a process for storing information on an MHL source device, in the MHL repeater device in the embodiment; and

FIG. 5 is an exemplary flowchart illustrating the procedure of a process for relaying between an MHL sink device and the MHL source device, in the MHL repeater device in the embodiment.

### DETAILED DESCRIPTION

In general, according to one embodiment, an video relay device comprises a first port, a second port, and a transmission module. The first port is configured to connect to a video receiver compatible with an interface standard for video transmission. The second port is configured to connect to a plurality of video transmitters. The transmission module transmits a video signal indicating the video transmitters connected to the second port when it is determined that, in communication with the video receiver connected to the first port, the video receiver has a first version incompatible with connection to the video transmitters among a plurality of versions defined in the interface standard.

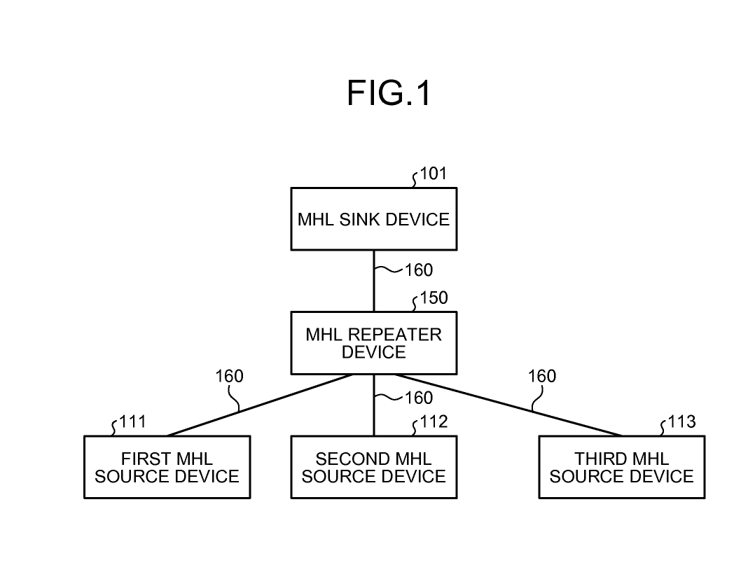

FIG. 1 is a diagram illustrating an example of a configuration of a video transmission system of an embodiment. An exemplary system illustrated in FIG. 1 comprises an MHL sink device 101, a first MHL source device 111, a second MHL source device 112, a third MHL source device 113, and an MHL repeater device 150. Further, video transmission between the above devices is implemented in conformity with the Mobile High-Definition Link (MHL) standard.

As the MHL sink device 101, for example, a digital television receiver is employed. Further, the MHL sink device 101 is not limited to the digital television receiver, and may be any device that can control display of video based on a received video signal. For example, a hard disk recorder or a set-top box may be used as the MHL sink device 101.

The MHL sink device 101 of the embodiment can receive an operation signal by a remote controller or the like, similarly to the digital television receiver. Further, the MHL sink device 101 of the embodiment can transmit the received operation signal, as an RCP command, to the MHL repeater device 150.

The first MHL source device 111, the second MHL source device 112, and the third MHL source device 113 are, for example, mobile devices, such as smartphones or tablet terminals.

Furthermore, the plurality of the MHL source devices 111 to 113 transmit video data to the MHL sink device 101 via the MHL repeater device 150 through an MHL cable 160 by using a protocol based on the MHL standard.

Moreover, when receiving the RCP command, the MHL source devices 111 to 113 can perform a process according to the RCP command.

Meanwhile, the version of the MHL standard is upgraded according to user needs or the like. For example, in a new version of the MHL standard, as illustrated in FIG. 1, the MHL sink device 101 can connect to the plurality of the MHL source devices 111 to 113 via the MHL repeater device 150. To realize connection to a plurality of devices, for example, an MHL device compatible with the new version has a unique address for identifying a connection target from the plurality of the devices.

In contrast, the MHL standard of an older version than the new version assumes that an MHL sink device and an MHL source device are connected to each other on a one-to-one basis; therefore, an MHL device of the older version does not comprise a configuration for connecting to a plurality of devices.

However, it is preferable that even the MHL device of the older version of can connect to a plurality of devices similarly to the MHL device of the new version. Therefore, in the embodiment, the MHL repeater device 150 performs different control depending on the version of the MHL standard of a connected MHL sink device. Consequently, the MHL sink device can connect to a plurality of MHL source devices independent of the version of the MHL standard.

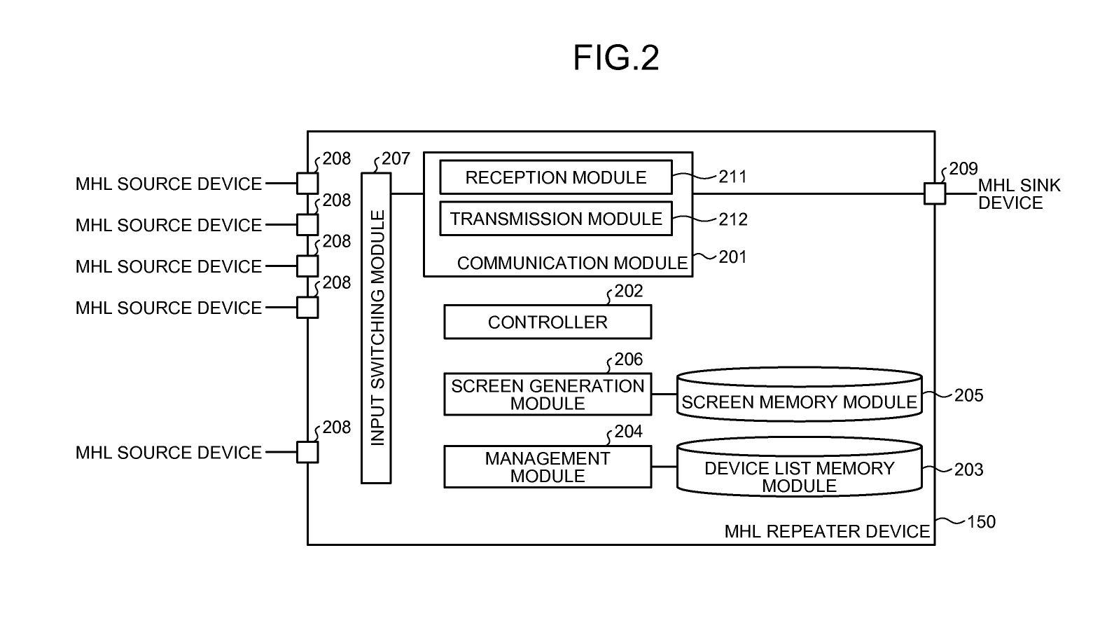

FIG. 2 is a block diagram illustrating an example of a configuration of the MHL repeater device 150. As illustrated in FIG. 2, the MHL repeater device 150 comprises a communication module 201, a controller 202, a device list memory module 203, a management module 204, a screen memory module 205, a screen generation module 206, an input switching module 207, uplink ports 208, and a downlink port 209.

A plurality of the uplink ports 208 are provided. The uplink ports 208 are configured to connect to MHL source devices compatible with the MHL standard that is an interface standard for video transmission. Further, by taking the MHL repeater device 150 as a center, a side where a plurality of MHL source devices (for example, the MHL source devices 111 to 113 in FIG. 1) are connected to the uplink ports 208, is referred to as an upstream side (uplink side).

Meanwhile, the embodiment is described with an example in which the MHL source devices compatible with the MHL standard are connected to the uplink ports 208; however, video transmission devices to be connected are not limited to the MHL source devices. The video transmission devices to be connected may be any devices that can transmit video. If video transmission devices based on other than the MHL standard are connected, the MHL repeater device 150 may perform control to convert video to a video signal or the like that can be recognized by a downlink side when transmitting the video to the downlink side. Further, it may be possible to connect MHL source devices incompatible with multiple device connection. In this case, the MHL repeater device 150 performs a necessary process, such as a process of assigning unique addresses to the MHL sources, to make the MHL source devices be compatible with the multiple device connection.

The controller 202 is configured to control the entire MHL repeater device 150.

Further, the controller 202 determines a version of the MHL standard with respect to the MHL sink device 101 on the basis of communication with the MHL sink device 101 connected to the downlink port 209 via the communication module 201. In the embodiment, the controller 202 determines whether the version of the MHL standard with respect to the MHL sink device 101 is a version that enables connection to a plurality of MHL source devices. The controller 202 performs different control depending on whether the version enables connection to a plurality of MHL source devices.

The downlink port 209 is configured to connect to an MHL source video receiver compatible with the MHL standard that is an interface standard for video transmission. Further, by taking the MHL repeater device 150 as a center, an MHL sink device (the MHL sink device 101 in FIG. 1) connected to the downlink port 209 is referred to as a downstream side (downlink side). Meanwhile, in the example illustrated in FIG. 2, an example will be described in which the single downlink port 209 is provided; however, it may be possible to provide a plurality of the downlink ports 209.

Furthermore, as long as the MHL sink device connected to the downlink port 209 is compatible with the MHL standard, whether the version enables connection to a plurality of MHL source devices or not is irrelevant.

While an example is illustrated in which the MHL source devices are connected to the upstream side, other MHL repeater devices may be connected to the upstream side in some cases. Further, while a configuration is illustrated in which the MHL sink device is connected to the downstream side, other MHL repeater device may be connected in some cases.

The device list memory module 203 stores therein information on each of the MHL source devices connected to the uplink ports 208 and the MHL sink device connected to the downlink port 209. Examples of the information on the MHL source devices and the MHL sink device include an address indicating a location of a device and information on a model of the device. The pieces of the information on the devices are stored in association with ports to which the respective devices are connected.

The management module 204 reads the pieces of the information on the devices connected to the uplink ports 208 and the downlink port 209 by referring to the device list memory module 203 according to a request from other components. Further, when a new device is connected to the uplink ports 208 or the downlink port 209, the management module 204 writes information on the connected device to the device list memory module 203.

The communication module 201 comprises a reception module 211 and a transmission module 212, and performs data communication with the MHL source devices (for example, the MHL source devices 111 to 113 in FIG. 1) and the MHL sink device (for example, the MHL sink device 101 in FIG. 1).

The reception module 211 receives data from the MHL source devices (for example, the MHL source devices 111 to 113 in FIG. 1) and the MHL sink device (for example, the MHL sink device 101 in FIG. 1). For example, the reception module 211 receives, as an RCP command from the MHL sink device connected to the downlink port 209, an operation signal received by the MHL sink device.

The transmission module 212 transmits data to the MHL source devices (for example, the MHL source devices 111 to 113 in FIG. 1) and the MHL sink device (for example, the MHL sink device 101 in FIG. 1).

For example, when the controller 202 determines that, in the communication with the MHL sink device connected to the downlink port 209, a version of the MHL sink device is an old version incompatible with connection to a plurality of source devices among a plurality of versions defined in the MHL standard, the transmission module 212 transmits a video signal containing screen information indicating a list of the MHL source devices connected to the uplink ports 208. The video signal is generated by the screen generation module 206 to be described later.

The screen memory module 205 stores therein information on a template, with which the screen generation module 206 generates the screen information, or the like.

The screen generation module 206 generates the screen information indicating a list of the MHL source devices based on the pieces of the information, which are about the MHL source devices connected to the uplink ports 208 and are received from the management module 204, and based on the template or the like stored in the screen memory module 205, in order to select an MHL source device to which the MHL sink device is to be connected.

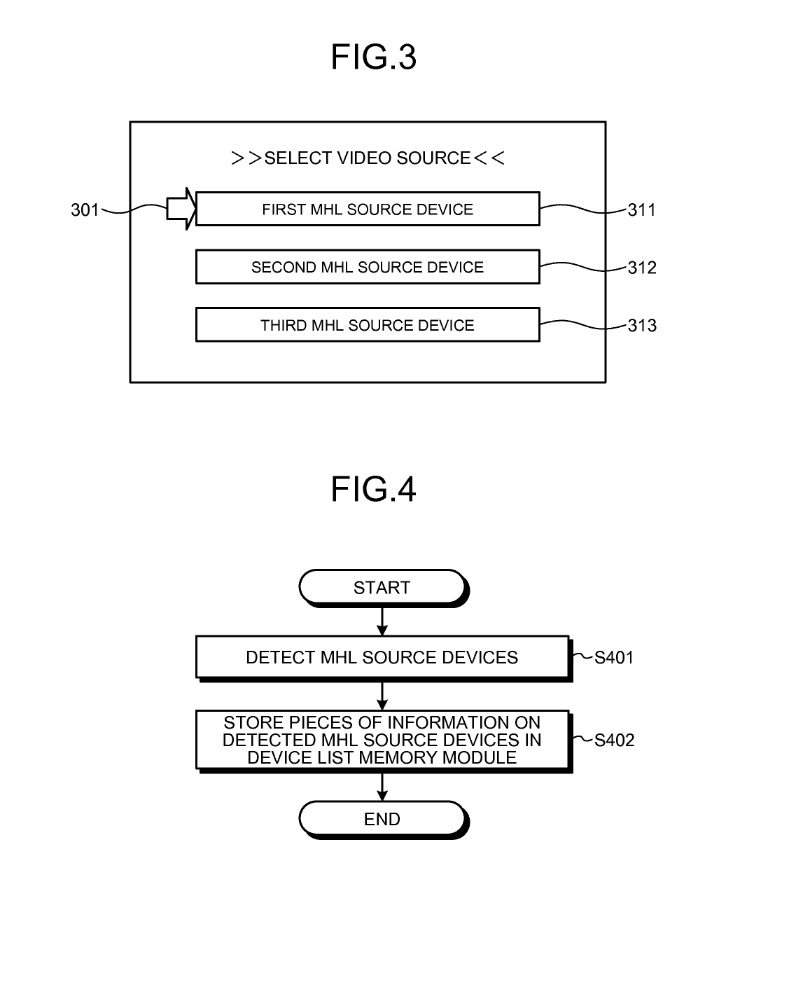

FIG. 3 is a diagram illustrating an example of a screen generated by the screen generation module 206. As illustrated in FIG. 3, a list of pieces of information for identifying the MHL source devices connected to the uplink ports 208 is displayed. The pieces of the information for identifying the MHL source devices are based on the pieces of the information stored in the device list memory module 203.

The transmission module 212 transmits a video signal containing the generated screen information to the MHL sink device 101 connected to the downlink port 209. Then, the MHL sink device 101 displays the screen information contained in the received video signal. Therefore, even the MHL sink device 101 of a version incompatible with connection to a plurality of MHL source devices can display a screen for selecting a destination to receive the video signal from among the MHL source devices.

When determining that a version of the MHL sink device 101 connected to the downlink port 209 is the old version incompatible with connection to a plurality of source devices among the versions defined in the MHL standard, the controller 202 performs control based on the signal received by the reception module 211 from the MHL sink device 101.

For example, every time the reception module 211 of the MHL repeater device 150 receives an RCP command indicating an operation signal of a cursor 301 illustrated in FIG. 3 from the MHL sink device 101, the controller 202 causes the screen generation module 206 to re-generate screen information, in which the cursor 301 has moved, in accordance with the RCP command. Then, a video signal containing the generated screen information is transmitted to the MHL sink device 101.

For another example, the controller 202 selects, as a connection destination, one of the MHL source devices 111 to 113 connected to the uplink ports 208 on the basis of the RCP command received from the MHL sink device 101.

Then, the controller 202 performs relay control to enable transmission and reception of information between the selected MHL source device and the MHL sink device 101 connected to the downlink port 209.

Specifically, if a version of the MHL sink device 101 is an old version incompatible with connection to a plurality of source devices among the plurality of versions defined in the MHL standard, the MHL sink device 101 assumes that the connected MHL repeater device 150 serves as a source device. Namely, when the MHL repeater device 150 according to the embodiment transmits a video signal for displaying a list of the MHL source devices to be selected, the MHL sink device 101 displays the video signal on the assumption that the video signal is transmitted from the source device. Therefore, a selection screen indicating a source list is displayed. Then, the MHL sink device 101 transmits a signal, such as an RCP command, to the MHL repeater device 150 assumed as the source device.

Accordingly, the MHL repeater device 150 performs a process corresponding to the signal received from the MHL sink device 101. For example, the MHL repeater device 150 performs control needed for selecting an MHL source device as a connection destination on the basis of the RCP command contained in the signal and relaying to the MHL source device. Consequently, even a version of the MHL sink device 101 is the old version, the MHL sink device 101 can connect to one of the MHL source devices 111 to 113 connected to the uplink ports 208.

In contrast, when the controller 202 determines that, in the communication with the MHL sink device connected to the downlink port 209, a version of the MHL sink device is a new version compatible with connection to a plurality of source devices among the versions defined in the MHL standard, the MHL repeater device 150 functions as a normal repeater device. For example, the MHL repeater device 150 transmits data received by the reception module 211 to an address (for example, an address indicating one of the MHL source devices 111 to 113 and the MHL sink device 101) assigned to the data. In this case, the transmission module 212 does not transmit a video signal that is generated by the screen generation module 206 as described above.

The input switching module 207 performs control to switch a signal transmission/reception destination among the MHL source devices connected to the uplink ports 208. For example, when the controller 202 selects an MHL source device to be connected to the MHL sink device, a port number of the selected MHL source device is set to active.

Further, when a version of the MHL sink device 101 is the newer version of the MHL standard, and if the RCP command transmitted from the MHL sink device 101 is an input switch command, the input switching module 207 sets a port number designated by the input switch command to active.

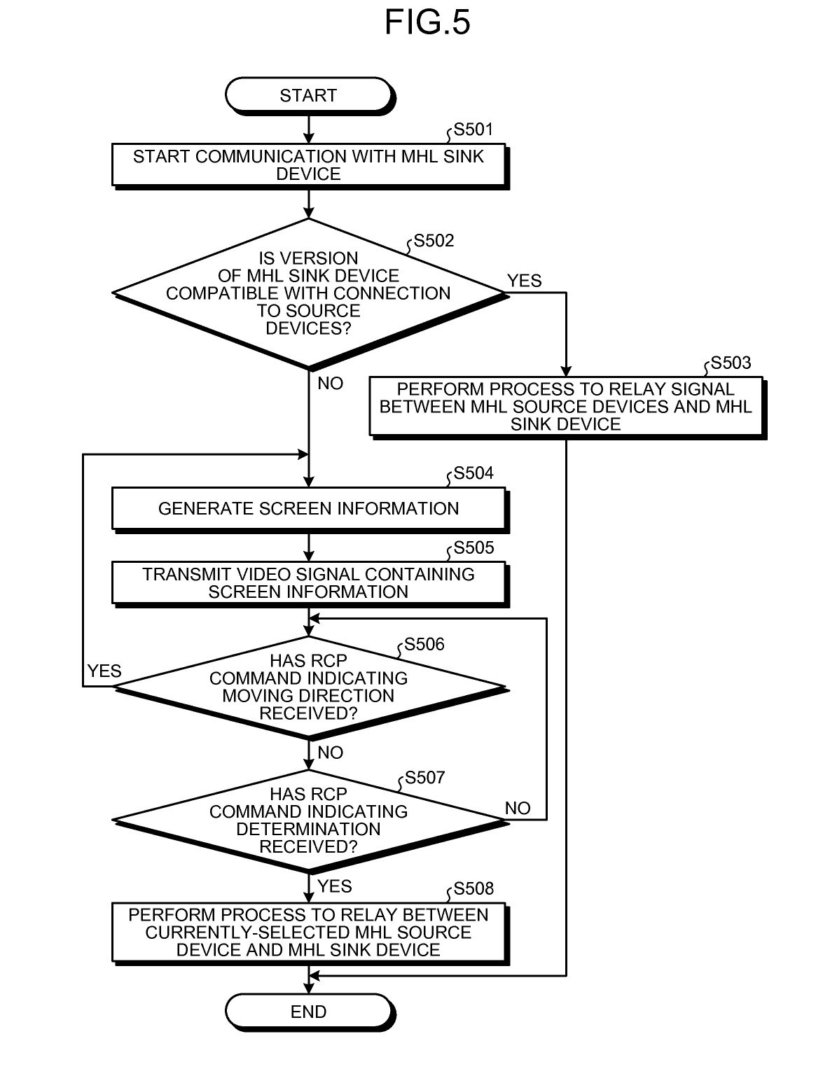

Next, a process of storing information on the MHL source device in the MHL repeater device 150 of the embodiment will be described. FIG. 4 is a flowchart illustrating the procedure of the above described process in the MHL repeater device 150 of the embodiment.

First, the communication module 201 detects the MHL source devices connected to the uplink ports 208 (S401). Meanwhile, a method of detecting the MHL source devices may be any method based on the MHL standard.

Then, the management module 204 stores pieces of information on the detected MHL source devices in the device list memory module 203 in association with port numbers at which the respective MHL source devices are detected (S402).

Through the above described process, it is possible to store information on connected devices in the device list memory module 203. Therefore, it is possible to display a list of connectable MHL source devices with respect to the MHL sink device.

Next, a process for relaying between the MHL sink device and the MHL source device in the MHL repeater device 150 of the embodiment will be described. FIG. 5 is a flowchart illustrating the procedure of the above described process in the MHL repeater device 150 of the embodiment.

First, the communication module 201 starts communication with the MHL sink device connected to the downlink port 209 (S501).

Then, the controller 202 determines whether a version of the MHL sink device is compatible with connection to a plurality of source devices (S502). As a method of this determination, a version determination method based on the MHL standard is used.

If the controller 202 determines that the version of the MHL sink device is compatible with connection to a plurality of source devices (S502: Yes), the MHL repeater device 150 performs a process to relay a signal between the MHL source devices connected to the uplink ports 208 and the MHL sink device in accordance with control defined by the version (S503).

In contrast, if the controller 202 determines that the version of the MHL sink device is not compatible with connection to a plurality of source devices (S502: No), the screen generation module 206 generates screen information to select an MHL source device as a connection destination (S504). The screen information to be generated may be the screen illustrated in FIG. 3 by way of example.

The transmission module 212 transmits a video signal containing the generated screen information to the MHL sink device 101 (S505).

Thereafter, it is determined whether the reception module 211 has received an RCP command indicating a moving direction from the MHL sink device 101 (S506). If the reception is done (S506: Yes), the screen generation module 206 generates screen information, in which the cursor 301 has moved along the moving direction in the exemplary screen illustrated in FIG. 3 (S504), and the process proceeds to S505. To perform this control, the MHL repeater device 150 stores therein information as to which one of selection fields 311 to 313 displaying the MHL source devices as illustrated in FIG. 3 is currently selected.

In contrast, if it is determined that the reception module 211 has not received the RCP command indicating the moving direction from the MHL sink device 101 (S506: No), it is determined whether the reception module 211 has received an RCP command indicating determination from the MHL sink device 101 (S507). If it is determined that the RCP command indicating determination has not been received (S507: No), the process returns to S506.

In contrast, if it is determined that the reception module 211 has received the RCP command indicating determination from the MHL sink device 101 (S507: Yes), the controller 202 performs control to relay between the currently-selected MHL source device and the MHL sink device (S508).

In the embodiment, the MHL repeater device 150 performs the above described control, so that even when a version of the MHL sink device is not a version that enables connection to a plurality of MHL source devices, it is possible to implement a function to connect to one of MHL source devices. Further, it is possible to connect devices of different versions to one another as long as the devices are compatible with the MHL standard. Consequently, it becomes possible to improve convenience for users.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An video relay device comprising:
a first port configured to connect to a video receiver compatible with an interface standard for video transmission;
a second port configured to connect to a plurality of video transmitters; and
a transmission module configured to transmit a video signal indicating the video transmitters connected to the second port when it is determined that, in communication with the video receiver connected to the first port, the video receiver has a first version incompatible with connection to the video transmitters among a plurality of versions defined in the interface standard.

2. The video relay device of claim 1, further comprising:
a reception module configured to receive, from the video receiver connected to the first port, an operation signal received by the video receiver; and
a controller configured to relay between one of the video transmitters connected to the second port and the video receiver connected to the first port on the basis of the operation signal received by the reception module, so that information can be transmitted and received between the one of the video transmitters and the video receiver.

3. The video relay device of claim 1, wherein when it is determined that, in communication with the video receiver, the video receiver has a second version compatible with connection to the video transmitters among the versions defined in the interface standard, the transmission module is configured not to transmit the video signal.

4. The video relay device of claim 2, wherein
when it is determined that the video receiver has the first version incompatible with connection to the video transmitters among the versions defined in the interface standard, the controller is configured to perform control based on a signal received by the reception module, and
when it is determined that the video receiver has the second version compatible with connection to the video transmitters among the versions defined in the interface standard, the transmission module is configured to transmit a signal received by the reception module to an address assigned to the signal.
